(19) United States
(12) Patent Application Publication
(10) Pub. No.: US 2017/0189970 A1
(43) Pub. Date: Jul. 6, 2017

(54) BIDIRECTIONAL ADJUSTING CUTTER HOLDER

(71) Applicant: Ching-Ting CHEN, Taichung City (TW)

(72) Inventor: Ching-Ting CHEN, Taichung City (TW)

(21) Appl. No.: 14/987,183

(22) Filed: Jan. 4, 2016

(51) Int. Cl. B23B 31/02; B23B 31/20

(52) U.S. Cl. CPC B23B 31/026; B23B 31/20; B23B 2231/22; B23B 2231/365; B23B 2260/004

(57) ABSTRACT

A cutter holder has a body, a collet fastening unit, a collet, a cutter, multiple concentricity adjusting units, and multiple straightness adjusting units. The collet fastening unit is assembled on the body. The collet is assembled on the collet fastening unit. The cutter is inserted into the collet. The body has a fastening flange which has multiple concentricity adjusting holes. The multiple concentricity adjusting units are respectively screwed in the multiple concentricity adjusting holes and abut against the collet fastening unit to correct the error of concentricity between the cutter and the body. The collet fastening unit has an assembling flange which has multiple straightness adjusting holes. The multiple straightness adjusting units are respectively screwed in the multiple straightness adjusting holes and abut against the body to correct the error of straightness between the body and the cutter.

### BACKGROUND OF THE INVENTION

1. Field of the Invention

The present invention relates to a machine tool, and more particularly to a bidirectional adjusting cutter holder that can adjust both the errors of concentricity and straightness.

2. Description of Related Art

A cutter holder is a tool which is assembled on a machine for cutting materials. With the reference to FIGS. 7A, 7B, 8A, and 8B, a conventional cutter holder 90 comprises a body 91, a collet fastening unit 92, a collet 93, a cutter 94, and a fastening cap 95. The collet fastening unit 92 is assembled on the body 91. The collet 93 is assembled on the collet fastening unit 92. The cutter 94 is inserted in the collet 93. The fastening cap 95 is assembled on the body 10, and the cutter 94 extends through the fastening cap 95. The body 91 has a body axis 911. The cutter 94 has a cutter axis 941. Errors occur inevitably in concentricity and straightness due to failure of assembling and manufacturing. With reference to FIG. 7, as an error of concentricity occurs, the cutter axis 941 is misaligned with the body axis 911. An interval G is formed between the cutter axis 941 and the body axis 911. With reference to FIG. 8, as an error of straightness occurs, the cutter axis 941 and the body axis 911 are non-parallel to each other. An angle A is formed between the cutter axis 941 and the body axis 911. The error of concentricity and the error of straightness may cause unbalance of the cutter holder and diminish machining accuracy.

To overcome the shortcomings of the conventional cutter holder, the present invention provides a bidirectional adjusting cutter holder to mitigate or obviate the aforementioned problems.

### SUMMARY OF THE INVENTION

The main objective of the present invention is to provide a bidirectional adjusting cutter holder that can adjust the error of concentricity and the error of straightness to perform machining precisely.

The cutter holder comprises a body, a collet fastening unit, a collet, a cutter, multiple concentricity adjusting units, and multiple straightness adjusting units. The collet fastening unit is assembled on the body. The collet is assembled on the collet fastening unit. The cutter is inserted into the collet. The body has a fastening flange which has multiple concentricity adjusting holes. The multiple concentricity adjusting units are respectively screwed in the multiple concentricity adjusting holes and abut against the collet fastening unit to correct the error of concentricity between the cutter and the body. The collet fastening unit has an assembling flange which has multiple straightness adjusting holes. The multiple straightness adjusting units are respectively screwed in the multiple straightness adjusting holes and abut against the body to correct the error of straightness between the body and the cutter.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a bidirectional adjusting cutter holder in accordance with the present invention;

FIG. 2 is an exploded perspective view of the cutter holder in FIG. 1;

FIG. 3 is a front view of the cutter holder in FIG. 1;

FIG. 4 is a cross sectional side view of the cutter holder along the line 4-4 in FIG. 3;

FIG. 5 is a cross sectional side view of the cutter holder along the line 5-5 in FIG. 3;

FIG. 6 is a perspective view of the cutter holder in FIG. 1 assembled with another collet fastening unit;

FIG. 7A is a side view in partial section of a conventional cutter holder;

FIG. 7B is an enlarged side view of the conventional cutter holder in FIG.

7A;

FIG. 8A is another side view in partial section of the conventional cutter holder; and

FIG. 8B is an enlarged side view of the conventional cutter holder in FIG. 8A.

### DETAILED DESCRIPTION OF PREFERRED EMBODIMENT

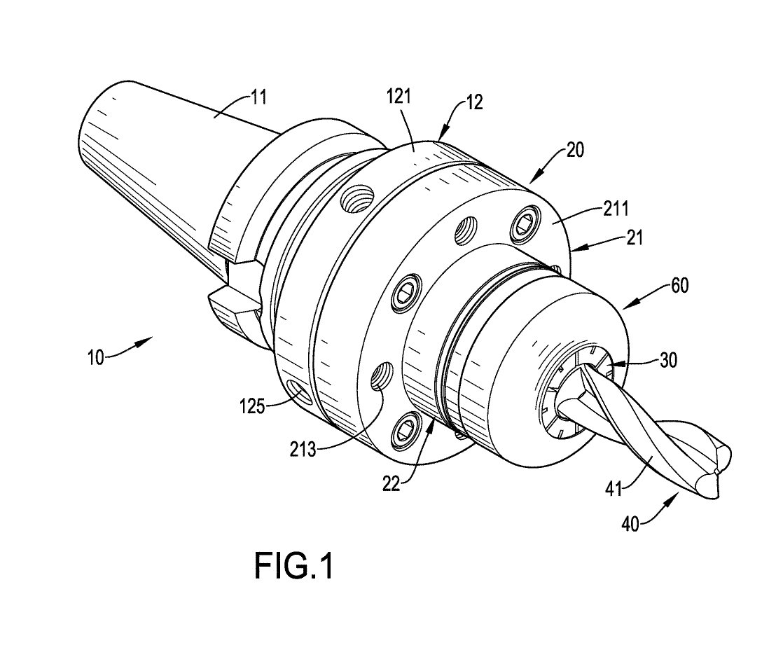

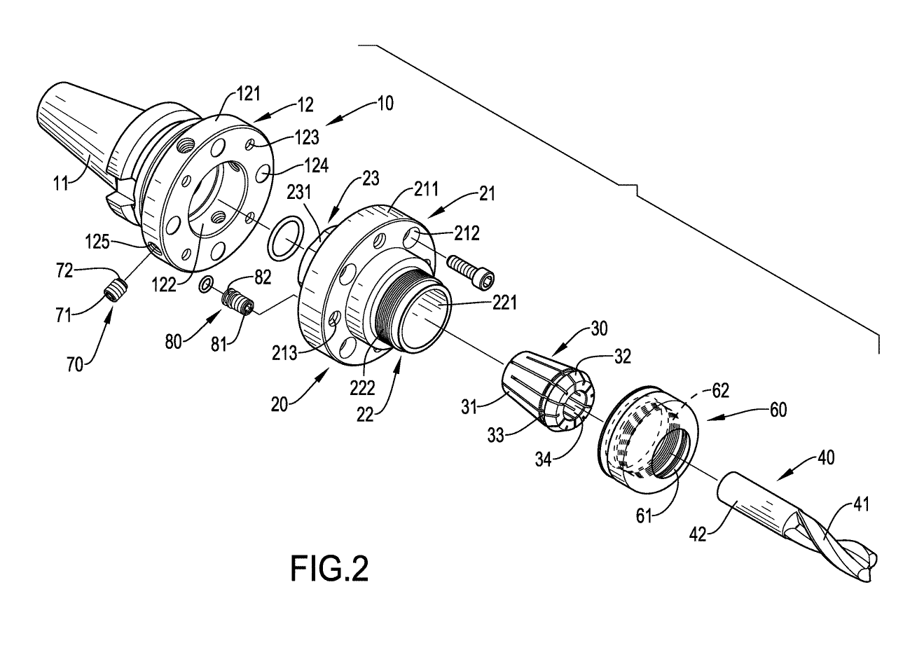

With reference to FIG. 1 and FIG. 2, a bidirectional adjusting cutter holder in accordance with the present invention comprises a body 10, a collet fastening unit 20, a collet 30, a cutter 40, a fastening cap 60, multiple concentricity adjusting units 70, and multiple straightness adjusting units 80. The collet fastening unit 20 is assembled on the body 10. The collet 30 is assembled on the collet fastening unit 20. The cutter 40 is inserted in the collet 30. The fastening cap 60 is assembled on the collet fastening unit 20. The multiple concentricity adjusting units 70 are screwed with the body 10. The multiple straightness adjusting units 80 are screwed with the collet fastening unit 20.

With reference to FIG. 1 and FIG. 2, the body 10 has two opposite ends, a fastening portion 11, and a fastening flange 12. The fastening portion 11 is conical and is disposed at one of the ends of the body 10. The fastening flange 12 is disposed at the other end of the body 10 and has a flange body 121, an assembling recess 122, multiple threaded holes 123, multiple abutting portions 124, and multiple concentricity adjusting holes 125. The flange body 121 is a round block. The flange body 121 has an end face and a peripheral surface. The end face of the flange body 121 has a center. The assembling recess 122 is axially defined in the center of the end face of the flange body 121 and has a circular cross section.

With reference to FIG. 1 and FIG. 2, the multiple threaded holes 123 surround the assembling recess 122 and are longitudinally defined through the flange body 121. Each threaded hole 123 has an inner surface and a thread formed on the inner surface of the threaded hole 123. The multiple threaded holes 123 are implemented as four in amount. The four threaded holes 123 are disposed at equal angular intervals. The multiple abutting portions 124 surround the assembling recess 122 and are longitudinally formed on the end face of the flange body 121. Each abutting portion 124 may be a recess. The abutting portions 124 are implemented as four in amount and are disposed at equal angular intervals. Each abutting recess 124 is disposed between two adjacent threaded holes 123.

With reference to FIG. 1 and FIG. 2, the multiple concentricity adjusting holes 125 are radially defined through the peripheral surface of the flange body 121 at intervals and communicate with the assembling recess 122. The multiple concentricity adjusting holes 125 are implemented as four, and the four concentricity adjusting holes 125 are disposed at equal angular intervals. Each concentricity adjusting hole 125 has an inner surface and a thread formed on the inner surface of the concentricity adjusting hole 125.

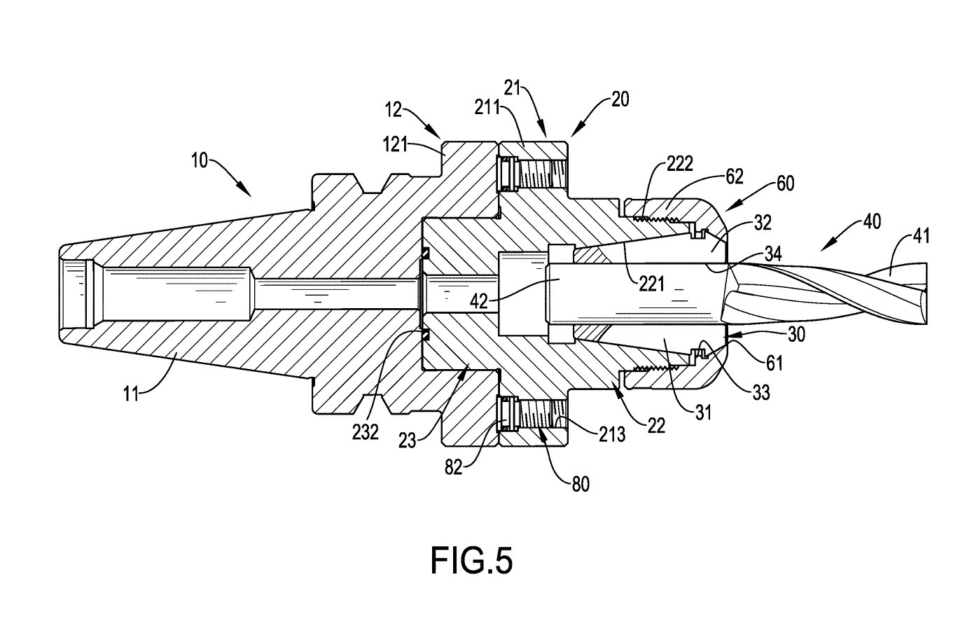

With reference to FIGS. 1, 2 and 5, the collet fastening unit 20 is assembled on the body 10 and has an assembling flange 21, a collet assembling section 22, and a body assembling section 23. The assembling flange 21 has a main body 211, multiple fastening holes 212, and multiple straightness adjusting holes 213. The main body 211 is a round block and has an axis and two opposite side faces. The fastening holes 212 correspond in position to the multiple threaded holes 123 and are disposed around the axis of the main body 211. The fastening holes 212 are implemented as four in amount correspondingly. Each fastening hole 212 is longitudinally defined through the main body 211. The multiple straightness adjusting holes 213 correspond in amount and position to the multiple abutting portions 124 and are disposed around the axis of the main body 211. The multiple straightness adjusting holes 213 are implemented as four in amount correspondingly. The four straightness adjusting holes 213 are disposed at equal angular intervals. Each straightness adjusting hole 213 is longitudinally defined through the main body 211. Each straightness adjusting hole 213 has an inner surface and a thread formed on the inner surface of the straightness adjusting hole 213.

With reference to FIGS. 1, 2 and 5, the collet assembling section 22 is axially formed on and protrudes from one of the side faces of the main body 211. The collet assembling section 22 has a peripheral surface, a free end away from the main body 211, an inner socket 221, and a first screwing portion 222. The free end of the collet assembling section 22 has an end face. The inner socket 221 is a tapered hole and is defined in the end face of the collet assembling section 22. The inner socket 221 extends from the free end of the collet assembling section 22 to the main body 211. The first screwing portion 222 is adjacent to the free end of the collet assembling section 22 and has a thread formed on the peripheral surface of the collet assembling section 22.

With reference to FIGS. 1, 2 and 4, the body assembling section 23 is axially formed on and protrudes from the side face of the main body 211 that is opposite the collet assembling section 22. The body assembling section 23 and the collet assembling section 22 are respectively disposed on the two side faces of the main body 211. The body assembling section 23 has a peripheral surface, a free end away from the main body 211, multiple abutting faces 231, and a receiving recess 232. The free end of the body assembling section 23 has an end face. The multiple abutting faces 231 correspond in position to the concentricity adjusting holes 125 and are formed on the peripheral surface of the body assembling section 23. The multiple abutting faces 231 correspond in amount to the concentricity adjusting holes 125 and are implemented as four in amount. The four abutting faces 231 are disposed at equal angular intervals. The receiving recess 232 is annular and is defined in the end face of the free end of the body assembling section 23. A seal is mounted in the receiving recess 232. The body assembling section 23 is mounted in the assembling recess 122 of the fastening flange 12. The collet fastening unit 20 is connected to the body 10 by four bolts. The four bolts are respectively mounted through the four fastening holes 212 and are respectively screwed in the four threaded holes 123 of the body 10.

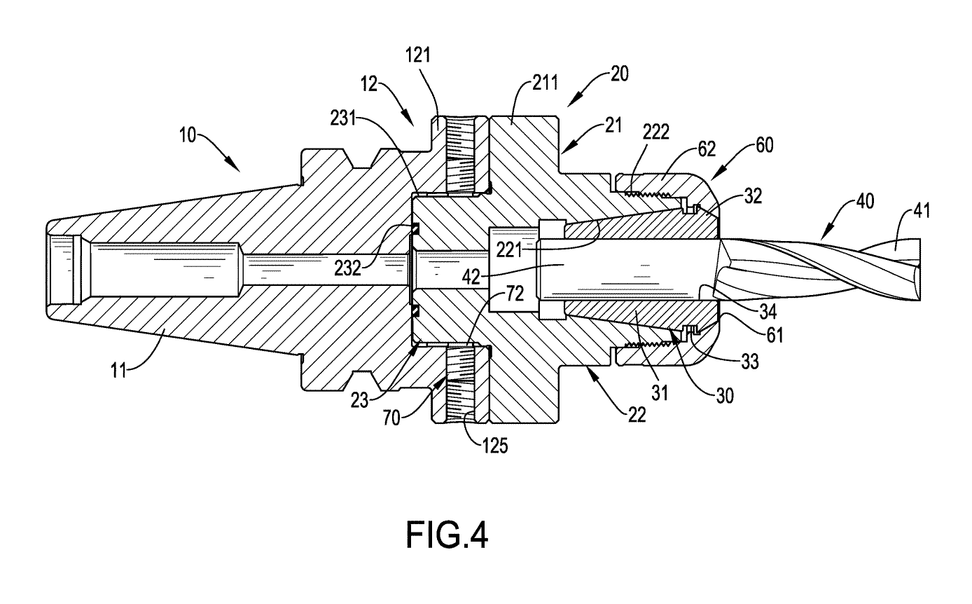

With reference to FIG. 2 and FIG. 4, the collet 30 has two opposite ends, a conjoint portion 31, a fastening cap abutting portion 32, an annular groove 33, and a central hole 34. The conjoint portion 31 is conical and corresponds to the inner socket 221 in sectional shape. The conjoint portion 31 is disposed at one of the ends of the collet 30. The fastening cap abutting portion 32 has an inclined abutting face and is located at the other end of the collet 30. The annular groove 33 is formed between the conjoint portion 31 and the fastening cap abutting portion 32. The central hole 34 is defined axially through the collet 30 from the conjoint portion 31 to the fastening cap abutting portion 32 and has an inner diameter. The conjoint portion 31 of the collet 30 is mounted in the inner socket 221 of the collet assembling section 22 of the collet fastening unit 20.

With reference to FIGS. 1, 2 and 4, the cutter 40 has two opposite ends, a cutting portion 41, and a collet assembling portion 42. The cutting portion 41 is located at one of the ends of the cutter 40. The collet assembling portion 42 is located at the other end of the cutter 40 and has an outer diameter. The outer diameter of the collet assembling portion 42 is substantially equal to the inner diameter of the central hole 34 of the collet 30. The collet assembling portion 42 of the cutter 40 is mounted in the central hole 34 of the collet 30.

With reference to FIGS. 1, 2 and 4, the fastening cap 60 has a cap plate, a side wall, a through hole 61, and a second screwing portion 62. The side wall is connected to the cap plate and has an inner surface. The through hole 61 is axially defined through the cap plate. The second screwing portion 62 has a thread formed on the inner surface of the side wall. The second screwing portion 62 is screwed with the first screwing portion 222 of the collet assembling section 22. The fastening cap 60 is assembled on the collet assembling section 22 of the collet fastening unit 20, and the cutting portion 41 of the cutter 40 is allowed to protrude from the through hole 61 of the fastening cap 60.

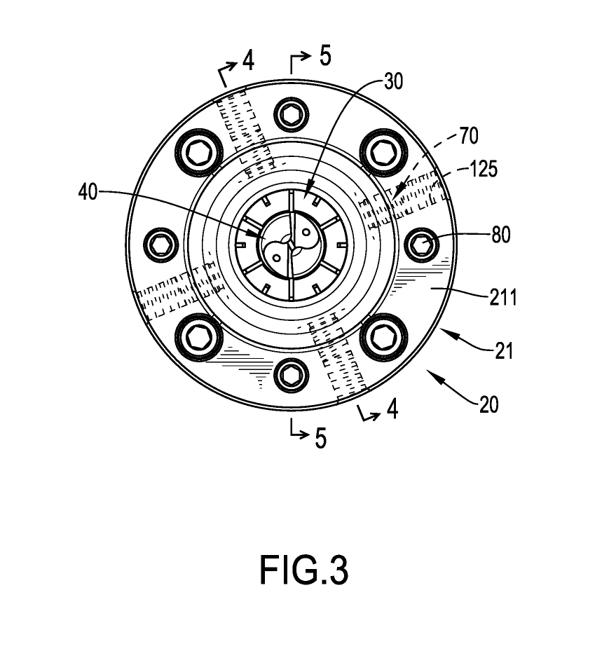

With reference to FIGS. 2, 3 and 4, each concentricity adjusting unit 70 is rod like and has two opposite ends, a surface, an outer thread, a recess 71, and an abutting portion 72. The outer thread of the concentricity adjusting unit 70 is formed on the surface of the concentricity adjusting unit 70. The recess 71 has a hexagonal cross section and is axially defined in one of the ends of the concentricity adjusting unit 70. The recess 71 and the abutting portion 72 are respectively disposed at the two ends of the concentricity adjusting unit 70. The multiple concentricity adjusting units 70 correspond to the four concentricity adjusting holes 125 in amount and are implemented as four in amount. The four concentricity adjusting units 70 are respectively screwed in the four concentricity adjusting holes 125 and respectively abut against the four abutting faces 231 of the body assembling section 23. Turning a hex key inserted in the recess 71 of one of the concentricity adjusting units 70 can make the concentricity adjusting units 70 move radially and determine the abutment of the concentricity adjusting unit 70 against the collet fastening unit 20. Rotating the multiple concentricity adjusting units 70 can correct the error of concentricity between the cutter 40 and the body 10.

With reference to FIG. 2 and FIG. 4, each straightness adjusting unit 80 is rod like and has two opposite ends, a surface, an outer thread, a recess 81, and a receiving groove 82. The outer thread of the straightness adjusting unit 80 is formed on the surface of the straightness adjusting unit 80. The recess 81 has a hexagonal cross section and is axially defined in one of the ends of the straightness adjusting unit 80. The receiving groove 82 is adjacent to the other end of the straightness adjusting unit 80 and is defined in the surface of the straightness adjusting unit 80. An O-ring is mounted in the receiving groove 82. The multiple straightness adjusting units 80 are correspond to the four straightness adjusting holes 213 in amount and are implemented as four in amount. The four straightness adjusting units 80 are respectively screwed in the four straightness adjusting holes 213 and respectively abut against the four abutting portions 124 of the fastening flange 12. As an axis of the cutter 40 is non-parallel to an axis of the body 10, an angle is formed between the axis of the cutter 40 and the body 10. Turning the hex key inserted in the recess 81 of one of the straightness adjusting units 80 can modify the abutment of the straightness adjusting unit 80 against the body 10. Rotating the multiple straightness adjusting units 80 can correct the error of straightness between the cutter 40 and the body 10.

The multiple concentricity adjusting units 70 are respectively screwed in the multiple concentricity adjusting holes 125 and abut against the collet fastening unit 20 to correct the error of the concentricity between the cutter 40 and the body 10. The multiple straightness adjusting units 80 are respectively screwed in the multiple straightness adjusting holes 213 and abut against the body 10 to correct the error of the straightness between the cutter 40 and the body 10.

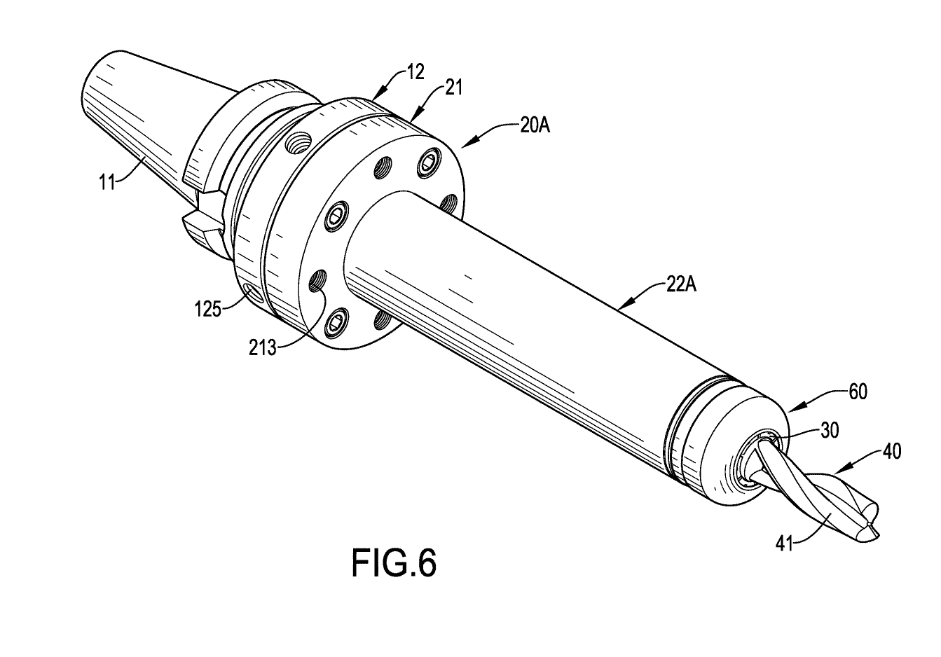

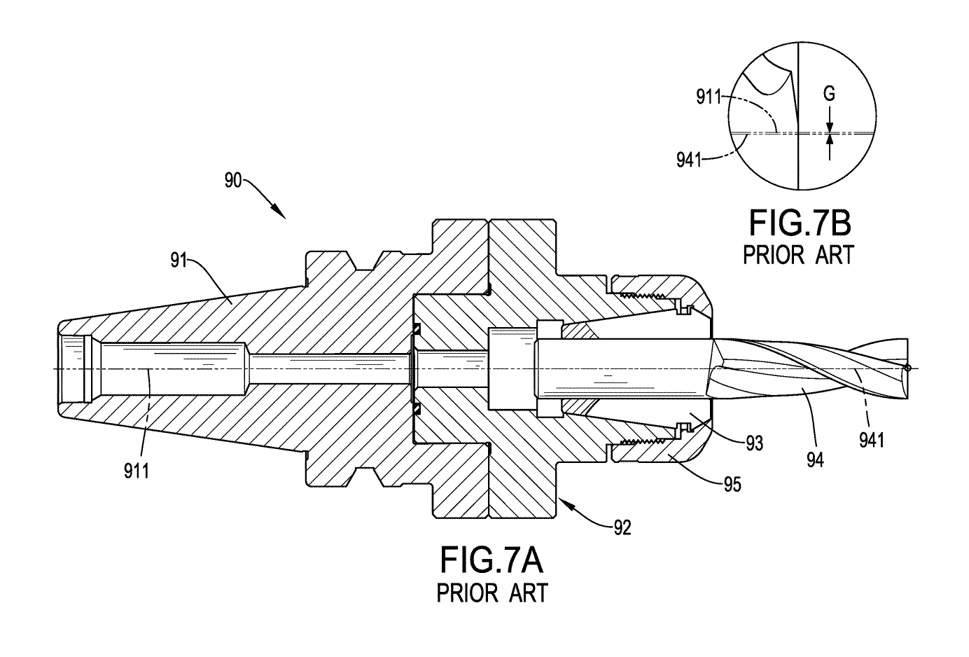

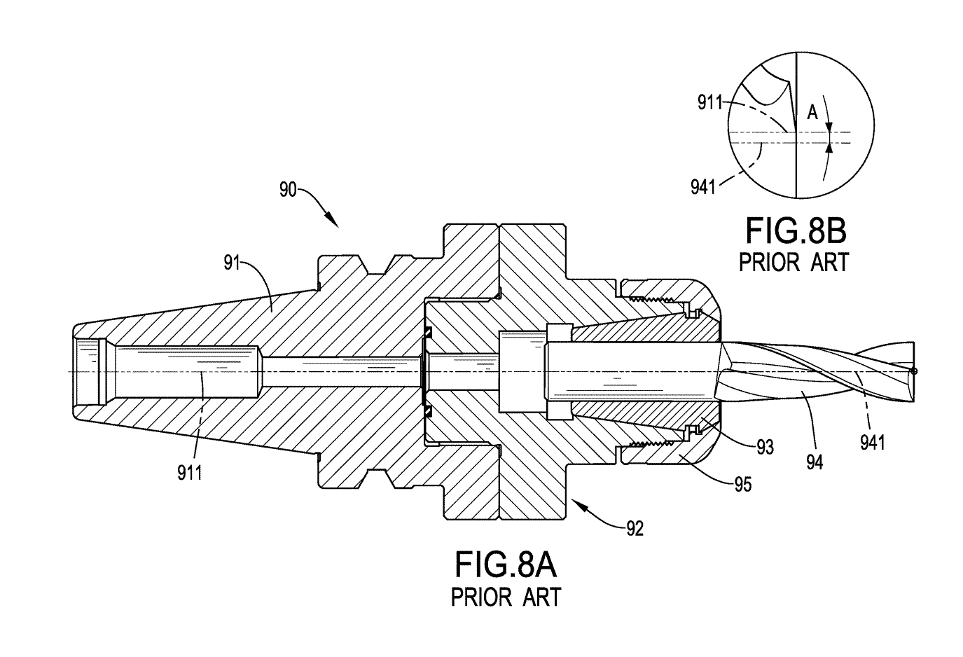

With reference to FIG. 6, when the body 10 is assembled by another collet fastening unit 20A which has a collet assembling section 22A with a longer length than the length of the collet assembling section 22 of the collet fastening unit 20, the influences of the error of the concentricity and the error of the straightness become obvious. Tuning the concentricity adjusting units 70 and the straightness adjusting units 80 not only improves the balance of the cutter holder and diminish the degree of wear and tear of the cutter 40 to prolong the service life of the cutter 40, but also improves the accuracy of machining and the quality of working pieces.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cutter holder comprising:
a body having
two opposite ends; and
a fastening flange disposed at one of the ends of the body and having
a flange body having an end face and a peripheral surface;
an assembling recess axially defined in the end face; and
multiple concentricity adjusting holes radially defined through the peripheral surface of the flange body at intervals and communicating with the assembling recess;
a collet fastening unit assembled on the body and having
an assembling flange having
a main body having an axis and two opposite side faces; and
multiple straightness adjusting holes disposed around the axis of the main body and longitudinally defined through the main body;
a collet assembling section axially formed on and protruding from one of the side faces of the main body, and having an inner socket axially defined in the collet assembling section; and
a body assembling section axially formed on and protruding from the side face of the main body that is opposite the collet assembling section, the body assembling section mounted in the assembling recess and having
a peripheral surface; and
multiple abutting faces corresponding in amount and position to the concentricity adjusting holes and formed on the peripheral surface of the body assembling section;
a collet mounted in the inner socket and having a central hole;
a cutter mounted in the central hole of the collet;
a fastening cap assembled on the collet assembling section and having a cap plate and a through hole axially defined through the cap plate, and the cutter extending through the through hole;
multiple concentricity adjusting units respectively screwed in the multiple concentricity adjusting holes and respectively abutting against the multiple abutting faces of the body assembling section; and
multiple straightness adjusting units respectively screwed in the multiple straightness adjusting holes and abutting against the fastening flange.

2. The cutter holder as claimed in claim 1, wherein
the body assembling section has
a free end away from the main body and having an end face; and
a receiving recess being circular and defined in the end face of the free end; and
a seal is mounted in the receiving recess.

3. The cutter holder as claimed in claim 2, wherein
each straightness adjusting unit has
two opposite ends;
a surface; and
a receiving groove close to one of the ends of the straightness adjusting unit and defined in the surface of the straightness adjusting unit; and
an O-ring is mounted in the receiving groove.

4. The cutter holder as claimed in claim 3, wherein
the fastening flange has multiple abutting portions disposed around the assembling recess, the multiple abutting portions longitudinally defined in the end face of the flange body;
the multiple straightness adjusting units respectively abut against the multiple abutting portions.

5. The cutter holder as claimed in claim 4, wherein
the concentricity adjusting holes are implemented as four in amount, and the four concentricity adjusting holes are disposed at equal angular intervals;
the multiple abutting faces are implemented as four in amount correspondingly, and the four abutting faces are disposed at equal angular intervals; and
the concentricity adjusting units are implemented as four in amount.

6. The cutter holder as claimed in claim 5, wherein
the abutting portions are implemented as four in amount, and the four abutting portions are disposed at equal angular intervals;
the straightness adjusting holes are implemented as four in amount correspondingly, and the four straightness adjusting holes are disposed at equal angular intervals; and
the straightness adjusting units are implemented as four in amount.
